(19) United States
(12) Patent Application Publication
(10) Pub. No.: US 2012/0216966 A1
(43) Pub. Date: Aug. 30, 2012

(54) Lift Mechanisms for Venetian Blind

(75) Inventors: Jorn Krab, Frederiksberg C. (DK); Svend-Erik Dahl, Hedehusene (DK)

(73) Assignee: Jorn Krab Holding APS, Copenhagen V. (DK)

(21) Appl. No.: 13/391,125

(22) PCT Filed: Aug. 19, 2010
(86) PCT No.: PCT/EP10/62104

§ 371 Date: Apr. 25, 2012

(30) Foreign Application Priority Data
Aug. 21, 2009 (EP) 09168386.2

(51) Int. Cl. E06B 9/32

(52) U.S. Cl. 160/168.1 P; 160/170

(57) ABSTRACT

The invention relates to an improved lift mechanism for a Venetian blind comprising a plurality of parallel elongated slats and pairs of Sift cords (19), where the lift mechanisms comprise a spool shaft (3) mounted for rotation with and axial displacement over a drive shaft (1) and guide means (5, 7) for maintaining the lift cords (19) in their proper axial position and for directing the lift cords (19) to the outer circumferential surface of said spool shaft (3), whereby the lift cords (19) upon rotation of said spool shaft (3) will become helically wound on or off the circumferential surface of the spool shaft (3) resulting in said slats being raised or lowered as the spool shaft (3) rotates The invention furthermore relates to systematic cascading of lift mechanisms for obtaining pairs of lift cords according to the number required for the job and for connection of drive motors.

### TECHNICAL FIELD

The present invention relates to lift mechanisms for Venetian blinds and to a Venetian blind comprising such mechanisms

### BACKGROUND OF THE INVENTION

The trend in many modern buildings is to use large window panels The architectural desires lead to façades that require screens against sunlight. Most commonly, conventional laminar blinds are used to provide the required shading. The size of the slats of such blinds and the maximum free span between the support cords are, however, limited. Simply scaling up the blinds and slats would lead to various kinds of stability problems. Typically in venetian blinds presently available, the slats have dimensions up to about 10 cm width and a free span between the support cords of about one meter. The limited span between the support cords and the consequent high number of support cords combined with a large number of narrow slats may spoil the original aesthetic effect provided by the large glass panels. Another solution has been to limit the size of the glass panels to the dimensions of the available blinds, thus limiting the architectural freedom.

Furthermore, large, unbroken window panels may lead to acoustical problems in the room bounded by these panels due to undesirable sound reflections from these panels. It would hence be desirable to have access to venetian blinds with extended length of the slats and corresponding extended span between support cords, which venetian blinds could also, for instance as an option, provide desired acoustical damping of reflections from panels covered by the venetian blinds.

Furthermore, the removal of slats for instance for replacement of these can in many prior art venetian blinds be a cumbersome process, for instance due to the lift cords being passed through passages in the individual slats and the slats being supported by the tilt cords according to the traditional ladder-cord arrangement. Such arrangements make the removal and replacement of individual slats difficult and often even impossible without dismantling major portions of the venetian blind. It would hence be desirable to provide venetian blinds of the above kind shaped and attached to tilt cords in a manner that would facilitate removal of individual slats. Furthermore, the provision of passages in the slats—either in the form of centrally located elongated slits as is often done for passage of the lift cords—or along the edge portions of the slats, for passage of attachment means for the tilt cords through each individual slat, is not optimal from a production point of view or from the point of view of cleaning of the slats. Moreover, it makes it difficult to prevent light from penetrating the slats through these passages and for instance the centrally located passages for the lift cord must necessarily be of a relative large lateral extension if the slats have to be able to undergo tilting over a major portion of the vertical tilt range from one of the slats' substantially vertical position through the horizontal position to the other substantially vertical position of the slats.

EP 1 557 524 discloses a mechanism for lift and tilt of Venetian slats up to considerable sizes. The mechanism comprises means for control of pairs of cords for lifting slats and pairs of cords for tilting the slats. The cords are arranged in pairs to be attached to the longitudinal edge portions of the slats.

### DISCLOSURE OF THE INVENTION

In order to obtain an aesthetically satisfactory effect, it is important to suspend and operate the slats in a manner that ascertains proper alignment of all slats both in situations where the slats are stationary and during raising, lowering and tilting operations of the slats, as even minor deviations from proper alignment may subtract materially from the overall appearance of the Venetian blind Wind-up systems where the cords are layered on top of each other would inevitably lead to length deviations between cords and pairs of cords which would cause the slats to be unevenly raised. This kind of lift systems would also cause variations in lift speed.

In order not to get the cords entangled, a certain amount of tightening up of the cords is normally necessary. In the above arrangement, the weight of the slats is considered sufficient load of the cords for pulling the cords out of the mechanisms during lowering the slats and retaining the cords in position during wind-in of the cords while raising the slats. But different tilt angles can lead to one cord of a pair being slack, and at lower weight of the slats or certain wind situations, the need for active tightening might not be fulfilled causing the lift cords to be entangled, which in turn can lead to disorder of the cords in the lift mechanism.

On this background, it is an object of the present invention to provide lift mechanisms for Venetian blinds of the above-mentioned kind, where the lift cords are actively pushed out of or held outside the mechanism without possibility of entangling the cords inside the mechanism.

It is another object of the present invention to present a mechanism that can be axially connected in cascade for provision of a plurality of pairs of cords driven for rotation by the same or separate winding motors such as electrical gear motors.

It is yet another object of the invention that the mechanism can be equipped with means for tilt of the slats when fully lowered without the risk of entangling the cords or be combined with a separate tilt mechanism of the kind described in EP 1 557 524 (hereby incorporated as reference) or as may else be conceived by a person skilled in the art.

The lift mechanism according to the invention comprises a spool shaft mounted for rotation with and axial displacement over said drive shaft within a concentric tubular housing and guide means for maintaining the lift cords in their proper axial position and for directing the lift cords to the outer circumferential surface of said spool shaft, whereby the lift cords upon rotation of said spool shaft will become helically wound on or off the circumferential surface of the spool shaft resulting in the slats being raised or lowered as the spool shaft rotates with constant relationship in velocity of the cords to the rotation of the drive shaft.

Since the lift cords are restricted from axial moving with respect to the slats and the wind-in of the pair of lift cords on the spool shaft is supposedly wound in one layer only in a helical way, an axial displacement of the spool shaft is necessary and this axial displacement in the present invention is advantageously controlled by the rotation of the drive shaft, hereby controlling the winding pitch.

According to a specific embodiment of the invention, which will be described in more detail in the detailed description of the invention, the axial displacement over the drive shaft is controlled by means of a rack and pinion system, where the circumferentially threaded pinion is rigidly connected to the spool shaft and rotationally coupled to the drive shaft, and the threads are in engagement with the stationary rack, said pinion operating as the axial driving means for the spool shaft in synchronisation with the drive shaft hereby controlling the pitch of the helical winding of the lift cords onto the spool shaft.

According to an alternative embodiment of the invention, the drive shaft of the lift mechanism in one or both ends has means for connecting to drive motors such as electric gear motors and/or shafts of other lift mechanisms for cascading of mechanisms when more pairs of lift cords are needed, for instance for longer venetian blinds or systems of venetian blinds.

The arrangement of unwinding of pairs of lift cords in perfect synchronism allows for attaching the lift cords to the slats along the longitudinal edge portions, which makes both initial assembling of the venetian blind easy and also facilitates removal and replacement of single slats without the necessity to dismantle major parts of the whole venetian blind. The easy initial assembling of even venetian blinds of considerable dimensions furthermore opens up for the possibility to purchase the venetian blind in the form of a kit to be easily assembled in situ. The slats can for instance be kept in stock in form of very long slats, which can be sold in the lengths actually needed. The ease of assembling the venetian blind in situ is also advantageous from a transportation point of view.

Also from a production point of view the unbroken surface of the slats together with the fact that the slats can be made in one piece for instance with the aid of a roll forming technique is highly advantageous.

### BRIEF DESCRIPTION OF THE DRAWINGS

The invention will now be described in more detail with reference to the accompanying drawings, in which

FIG. 1 is an exploded view of a preferred embodiment of the lift mechanism.

FIG. 2 is a schematic view of one half of the lift cord guide means housing showing channels and rotational directional change.

FIG. 3 is a schematic view of the second half of the lift cord guide means housing showing attachment means for one rack end.

FIG. 4 is a perspective view of the circumferentially threaded pinion with attachment means for the spool shaft.

FIG. 5 is a perspective view of the sealed complete lift mechanism assembly according to an embodiment.

### DETAILED DESCRIPTION OF THE INVENTION

In the following, a detailed description of a presently preferred embodiment of the lift mechanism according to the invention is given.

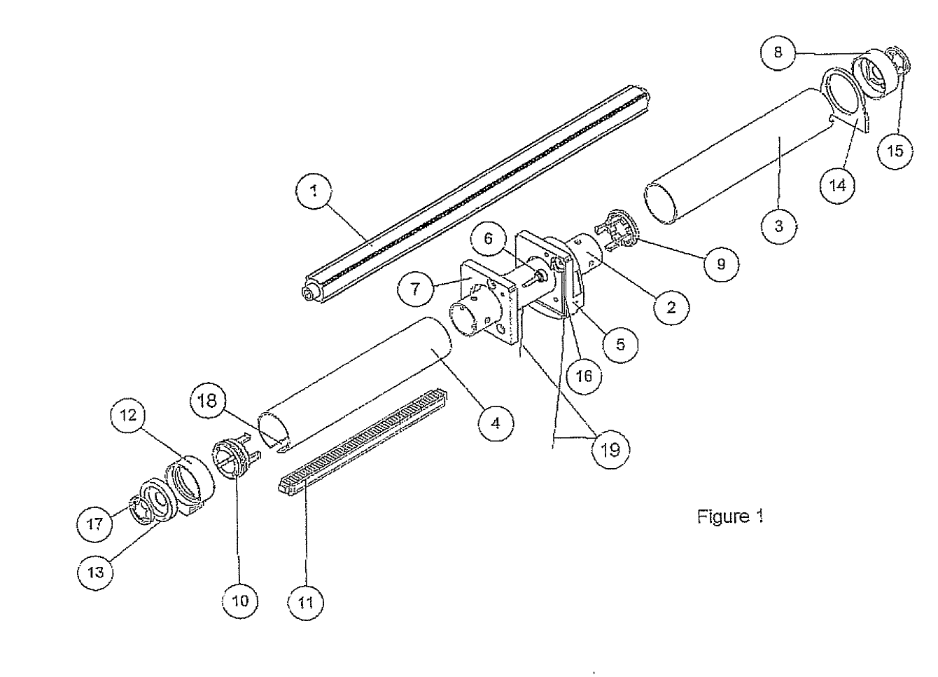

With reference to FIG. 1, a complete assembly of a lift mechanism according to an embodiment of the invention is shown in exploded view representation.

The circumferentially threaded pinion 10 and the cord lock 9 are in rotational engagement with the drive shaft 1 by means of a groove and tongue system. By means of protruding fingers and dents said circumferentially threaded pinion 10 and said cord lock 9 are engaged in corresponding notches in each end of the spool shaft 2. The circumferentially threaded pinion 10, the cord lock 9 and the spool shaft 2 hereby constitute a rotating and axially displaceable mechanism. The housing part 5 with cord guide means 22 (FIG. 2), cord reversing means 6 and cord channels 16 is additionally equipped with a seating 21 for the tubular housing 3. The housing part 7 in a similar fashion is equipped with a seating 23 for the rack rail housing 4 and a mounting base 24 for the rack rail 11. The rack rail housing 4 has a longitudinal cut-out 18 for accommodating the rack rail 11 and it is supported by a flanged joint 12, which latter also supports the opposite end of the rack rail 11. The tubular housing 3 distal to the rack rail housing 4 from the housing part 5 is supported by a flange 14. The tubular housing 3 together with the spool shaft 2 constitute a spool chamber between the outer periphery of the spool shaft 2 and the inner periphery of the tubular housing 3 creating a tubular gap with a uniform gap width preferably slightly less than or equal to the diameter of the lift cords 19. Both ends of the assembly is terminated with centring bushings 8 and 13 in opposite ends and held together by means of lock washers 15 and 17 fixed to the drive shaft 1. Since the circumferentially threaded pinion 10 is engaged with the stationary rack rail 11 in a linear worm gear type of drive, said mechanism will be displaced axially relative to the drive shaft 1 in perfect synchronisation with rotation of the drive shaft 1. Since the cord pair 19 is guided through the channels 16 into the guide means housing assembly 5, 7, around the spool shaft 2 and fixed by means of the concomitant rotating cord lock 9, and the spool shaft will be axially displaced while winding, said cord pair 19 will be wound onto the spool shaft 2 in a perfect helical winding gently squeezed between the spool shaft 2 and the tubular housing 3.

In the present embodiment, the lift cords during winding will be tightly packed with no possibility to get displaced or entangled. By counter rotating said mechanism, the lift cords will be unwound and pushed out of the cord channels 16 because of the rotation simultaneous with an axial displacement in the reverse direction of that from the wind-in sequence. In an advantageous embodiment, the outer periphery of the spool shaft 2 is treated to yield higher frictional force to the lift cords than the inner periphery of the tubular housing 3. The complete assembly can be fixed to a building part by means of the housing parts 5 and 7 and the flange 14.

With reference to FIG. 2, one half of the lift cord guide means housing 5 is shown. Guiding and attachment means are seen in perspective view in FIG. 2 b. Cord channels and an embodiment of cord reversing means 6 are shown in FIG. 2d. Outlet openings 22 in the housing 5 for the cords 19 through which the cords are pulled or pushed by means of the spool shaft 2 through channels 16 are shown in FIGS. 2a and 2b. Reversal of one of the lift cords is necessary for simultaneous wind-in or wind-out.

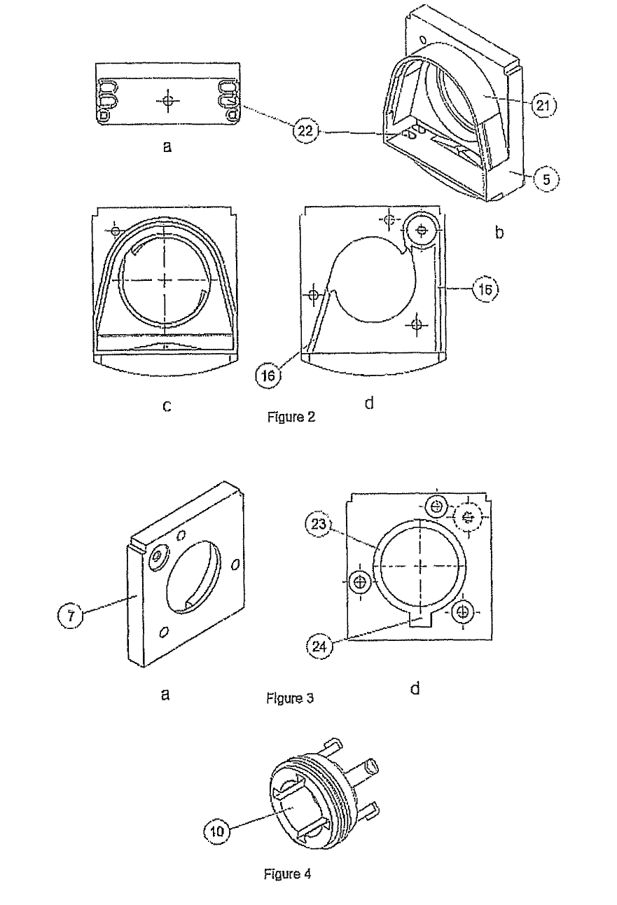

With reference to FIG. 3, this shows the other half of the lift cord guide means housing 7. Guiding for the rack rail 11 is delineated at the lowermost part of the circular guiding for the rack rail housing 4.

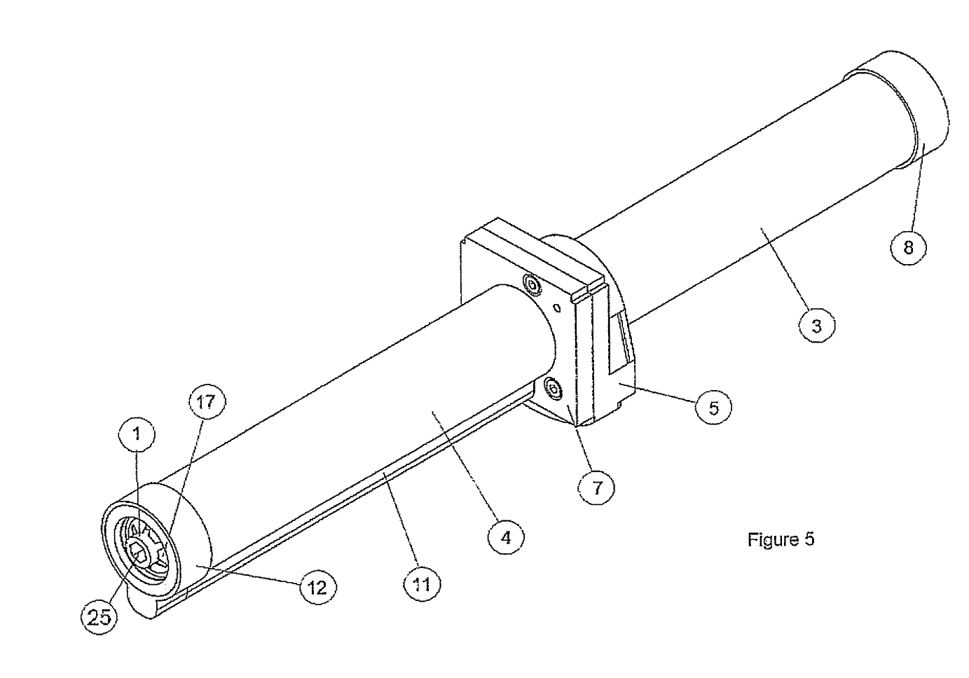

FIG. 4 shows a preferred embodiment of the circumferentially threaded pinion 10 with attachment means for the spool shaft 2 in a perspective view. In this embodiment, the rotational link between the pinion 10 and the drive shaft 1 is accomplished by means of the shown four grooves for meshing with corresponding four tongues on the drive shaft 1. Also shown are the threads on the outer periphery of the pinion. Spaced equally in between the grooves are four protruding fingers, each terminated in a dent for reaching into the spool shaft 2 and engagement with corresponding four notches in each end of the spool shaft 2. It is evident to a person skilled in the art that a connection of this kind can be realized in a lot of different ways.

FIG. 5 shows an embodiment of the invention, where the completely assembled lift mechanism constitutes an environmentally sealed system. As numeral 25 is indicated the means for coupling to drive/driven means or additional mechanisms in the shape of a hexagonal type of connection. It is implicit that many other functional versions could be applied for the purpose of connecting lift mechanisms.

Although only a limited number of embodiments of the present invention have been shown and described in the preceding parts of the detailed description, it is understood that a person skilled in the art may conceive other embodiments of the invention without departing from the scope of the invention as defined by the following claims.

### REFERENCE NUMERALS

1. drive shaft

2. spool shaft

3. tubular housing

4. rail housing

5. housing part

6. cord reversing means

7. housing part

8. centring bushing

9. cord lock and driver

10. circumferentially threaded pinion and driver

11. rack rail

12. flanged joint

13. centring bushing

14. flange

15. lock washer

16. cord channels

17. lock washer

18. longitudinal cut-out

19. lift cord pairs

20.

21. seating for tubular housing

22. cord guide means

23. seating for rack rail housing

24. mounting base for rack rail

25. means for coupling to drive/driven means or additional mechanisms

1. Lift mechanism for a venetian blind having a plurality of parallel elongated slats and pairs of lift cords, said lift mechanism comprises a spool shaft mounted for rotation with and axial displacement over a drive shaft within a concentric tubular housing and guide means for maintaining the lift cords in their proper axial position and for directing the lift cords to the outer circumferential surface of said spool shaft, whereby the lift cords upon rotation of said spool shaft will become helically wound on or off the circumferential surface of the spool shaft resulting in said slats being raised or lowered as the spool shaft rotates, characterised in that the space between said spool shaft and said tubular housing defines a cylindrical cavity with a uniform gap between the spool shaft and the tubular housing equal to or slightly smaller than the diameter of the lift cords, whereby spooling and unspooling of the lift cords through channels in the guide means are rendered possible without load on said lift cords.

2. A lift mechanism according to claim 1, characterised in that the axial displacement of the spool shaft over the drive shaft is controlled in synchronism with the rotation of said drive shaft, hereby controlling the pitch of the helical winding of the lift cords on the spool shaft.

3. A lift mechanism according to claim 1, characterised in that the axial displacement over the drive shaft is controlled by means of a linear worm gear type of rack rail and pinion system, where the circumferentially threaded pinion is rigidly connected to the spool shaft and rotationally coupled to the drive shaft and the threads are in engagement with the stationary rack rail, said pinion operating as the axial driving means for the spool shaft in synchronisation with the drive shaft, hereby controlling the pitch of the helical winding of the lift cords onto the spool shaft.

4. A lift mechanism according to claim 1, characterised in that the frictional forces between the lift cords and the outer periphery of the spool shaft are higher than the frictional forces between the lift cords and the inner periphery of the tubular housing.

5. A lift mechanism according to claim 1, characterised in that the completely assembled mechanism constitutes an environmentally sealed system.

6. A lift mechanism according to claim 1, characterised in the drive shaft having means for coupling to a drive motors output shaft and/or additional lift mechanisms.

7. A system of lift mechanisms, said lift mechanisms being in accordance with claim 6, characterised in that the system comprises one or more lift mechanisms, which by means of connecting members meshing with said means for coupling are rotationally connected to a drive motor output shaft and/or connected to each other.

8. A system of lift mechanisms according to claim 7, characterised in that said connecting members are flexible or angular, whereby said lift mechanisms connected to each other by means of said connecting member need not be coaxial.

9. A system of lift mechanisms according to claim 7, characterised in that in conjunction with said connecting members one or more tilt mechanisms according to the state of the art could be comprised in said system.
